(19) United States
(12) Patent Application Publication
(10) Pub. No.: US 2010/0286354 A1
(43) Pub. Date: Nov. 11, 2010

(54) ALLYL ALCOHOL COPOLYMER AND PRODUCTION METHOD THEREOF

(75) Inventors: Nobuyuki Kibino, Oita-shi (JP); Yukiharu Hetsugi, Oita-shi (JP); Kazufumi Kai, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/810,444

(22) PCT Filed: Dec. 22, 2008
(86) PCT No.: PCT/JP2008/073899

§ 371 Date: Jun. 24, 2010

(30) Foreign Application Priority Data
Dec. 25, 2007 (JP) 2007-331407
Jun. 11, 2008 (JP) 2008-152788

(51) Int. Cl. C08F 216/08

(52) U.S. Cl. 526/348.8

(57) ABSTRACT

The invention relates to an allyl alcohol copolymer comprising structures represented by formula (1) and (2) as monomer units.

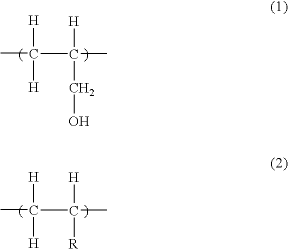

(In the formula, R represents an aliphatic hydrocarbon group having 2 to 20 carbon atoms, which may be branched or include a cyclic structure). The copolymer of the invention is excellent in compatibility with various resins, adhesiveness, electric insulation, low water absorption, thermal stability and surface active effect.

### TECHNICAL FIELD

The present invention relates to an allyl alcohol copolymer and a production method thereof.

### BACKGROUND ART

Olefin polymers having polar groups in the structure, having compatibility with various polar resins, excellent adhesiveness and colorability, are being widely used industrially. Although there have been various reports on production methods of olefin polymers having polar groups, most of the methods include introduction of polar-group-containing monomers through graft polymerization.

For example, Japanese Patent Application Laid-Open No. 2005-113038 (EP Patent No. 1674483) discloses a higher α-olefin polymer containing a polar group in which the polar group has been introduced by allowing a higher α-olefin polymer to react with a decomposition agent and a polar compound. In a method using graft polymerization, however, there is concern about degradation of the produced polymer due to oxidization and dispersibility of the polar group. Thus, such a method cannot be considered to be satisfactory in securing product quality.

There have been reports on examples of production method for solving the above problem by using copolymerization of polar-group-containing monomer and other olefin-based monomer, though not many. For example, Japanese Patent Application Laid-Open No. S64-54009 and Japanese Patent Application Laid-Open No. 2003-165809 are known. The methods described in these documents use anion polymerization, in which it is necessary to treat a polar-group-containing monomer with an equimolar amount or more of an organic metal compound in order for catalyst activity to be expressed. This is disadvantageous in production costs.

On the other hand, U.S. Pat. No. 5,444,141 discloses an example of a method for producing a copolymer by radical copolymerization between an allyl alcohol and an aromatic vinyl monomer. In this method, productivity of polymer can be improved and production costs can be reduced. The document, however, which discloses only copolymerization between allyl alcohol and styrene in its examples, and no example using other polymerizable monomers is included. Therefore, there have been demands for an efficient production method using a polar-group-containing polymerizable monomer having a carbon-carbon double bond other than styrene.

### DISCLOSURE OF INVENTION

The present invention provides an allyl alcohol copolymer and an efficient production method thereof.

As a result of intensive studies made with a view to solving the above problems, the present inventors have found that by allowing an allyl alcohol to react with an radically polymerizable aliphatic olefin compound, an unsaturated carboxylic acid or unsaturated carboxylic acid ester in the presence of a radical polymerization initiator, or by hydrogenating a copolymer of an allyl alcohol and an radical polymerizable aromatic monomer, a polymer having a polar group can be efficiently produced, whereby completing the present invention.

That is, the present invention relates to the following [1] to [11].

[1] An allyl alcohol copolymer comprising structures represented by formula (1) and (2) as monomer units.

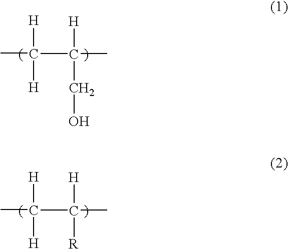

(In the formulae, R represents an aliphatic hydrocarbon group having 2 to 20 carbon atoms, which may be branched or include a cyclic structure).
[2] The allyl alcohol copolymer according to [1] above, comprising as monomer units the structures represented by formulae (1) and (2) only.
[3] The allyl alcohol copolymer according to [1] above, comprising as monomer units a structure represented by formula (1), a structure represented by formula (2), and a structure derived from an unsaturated carboxylic acid or unsaturated carboxylic acid ester.
[4] The allyl alcohol copolymer according to any one of [1] to [3] above, wherein the aliphatic hydrocarbon group having 2 to 20 carbon atoms represented by R in formula (2) is a linear aliphatic hydrocarbon group having 2 to 10 carbon atoms.
[5] The allyl alcohol copolymer according to any one of [1] to [3] above, wherein the aliphatic hydrocarbon group having 2 to 20 carbon atoms represented by R in formula (2) is an alicyclic hydrocarbon group having 6 to 10 carbon atoms.
[6] The allyl alcohol copolymer according to any one of [1] to [3] above, comprising 3 to 50 mol % of the monomer unit represented by formula (1).
[7] The allyl alcohol copolymer according to [3] above, comprising 0.1 to 5 mol % of the monomer unit derived from an unsaturated carboxylic acid or unsaturated carboxylic acid ester.
[8] The allyl alcohol copolymer according to any one of [1] to [7] above, wherein the hydroxyl value is within a range of 10 to 300 mgKOH/g.
[9] The allyl alcohol copolymer according to any one of [1] to [8] above, wherein the number average molecular weight (Mn) is within a range of 500 to 8000.
[10] A method of producing the allyl alcohol copolymer described in any one of [1] to [9] above, comprising at least a step of copolymerizing an allyl alcohol and an olefin compound corresponding to formula (2) in the presence of a radical polymerization initiator.
[11] A method of producing the allyl alcohol copolymer described in [5] above, comprising a step of hydrogenating a copolymer of an allyl alcohol and a radically polymerizable aromatic monomer.

According to the present invention, a copolymer of an allyl alcohol and an olefin compound or a copolymer of an allyl alcohol, an olefin compound and an unsaturated carboxylic acid or unsaturated carboxylic acid ester can be efficiently produced. The allyl alcohol copolymer obtained by the present invention, having a polar group, is excellent in compatibility with various resins and adhesion. Also, since the copolymer has a hydrophobic group, it is excellent in electric insulating property, low water absorption, thermal stability and surface activity effect. Thanks to these properties, the copolymer is useful as a resin improver, components in coating agent, ink, adhesive agent and primer, high-performance wax, compatibilizer, surfactant, additive for grease, urethane material and polyester material.

### BEST MODE FOR CARRYING OUT INVENTION

Hereinafter, the present invention is described in greater detail.

### [Allyl Alcohol Copolymer]

The allyl alcohol copolymer of the present invention comprises structures represented by formula (1) and (2) as monomer units.

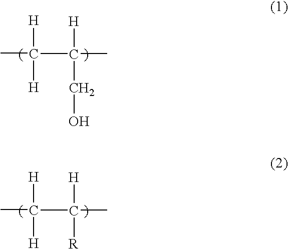

(In the formula, R represents an aliphatic hydrocarbon group having 2 to 20 carbon atoms, which may be branched or include a cyclic structure). If necessary, the copolymer may contain another monomer unit.

R in formula (2) represents an aliphatic hydrocarbon group having 2 to 20 carbon atoms, which may be linear or branched or include a cyclic structure.

Examples of linear aliphatic hydrocarbon group include ethyl group, n-propyl group, n-butyl group, n-pentyl group, n-hexyl group, n-octyl group, n-decyl group, n-dodecyl group, n-tetradecyl group, n-hexadecyl group, n-octadecyl group and n-eicosyl group.

Examples of branched aliphatic hydrocarbon group include isopropyl group, isobutyl group, sec-butyl group, neo-pentyl group, isohexylgroup, isooctyl group and isodecyl group.

Examples of aliphatic hydrocarbon group containing a cyclic structure include cyclohexyl group, cyclo hexylmethyl group, cyclohexylethyl group, decahydronaphthalenyl group and cyclohexenyl group.

Preferred among them as R are linear aliphatic hydrocarbon group having 2 to 10 carbon atoms and alicyclic hydrocarbon group having 6 to 10 carbon atoms in consideration for enhancement in compatibility with various resins. Particularly preferred in consideration for enhancement in compatibility with various resins are ethyl group, n-propyl group, n-butyl group, n-pentyl group, n-hexyl group, n-octyl group, n-decyl group, and cyclohexyl group.

There is no other limitation on the copolymer of the present invention as long as the copolymer comprises structures represented by formulae (1) and (2). If necessary, as a third monomer unit, a structure obtained by copolymerizing an unsaturated carboxylic acid or an unsaturated carboxylic acid ester may be introduced into the copolymer. Two or more kinds of such third monomer units may be introduced.

Examples of unsaturated carboxylic acid include acrylic acid, methacrylic acid, maleic acid, maleic anhydride, fumaric acid, and itaconic acid.

Examples of unsaturated carboxylic acid ester include monoesters and diesters of the above unsaturated carboxylic acids. Examples thereof include methyl acrylate, ethyl acrylate, (n-propyl) acrylate, n-butyl acrylate, methyl methacrylate, ethyl methacrylate, (n-propyl)methacrylate, (n-butyl)methacrylate, dimethyl maleate, diethyl maleate, di(n-propyl) maleate, di(n-butyl)maleate, dimethyl fumarate, diethyl fumarate, di(n-propyl)fumarate, di(n-butyl)fumarate, dimethyl itaconate, diethyl itaconate, di(n-propyl) itaconate, and di(n-butyl) itaconate.

Preferred unsaturated carboxylic acids among them are maleic anhydride and itaconic acid, in consideration for enhancement in productivity of the copolymer.

Preferred unsaturated carboxylic acid esters among them are maleic acid esters and itaconic acid esters in consideration for enhancement in productivity of the copolymer. Particularly preferred are dimethyl maleate, di(n-butyl)maleate and dimethyl itaconate.

In the allyl alcohol copolymer of the present invention, the bonding mode of the copolymer of the monomer unit represented by formula (1) and the monomer unit represented by formula (2) may be random, block or alternate, depending on polymerization conditions. In consideration for enhancement in compatibility with various resins, random mode is preferred. It is true of a case where the copolymer contains a third monomer unit.

In the allyl alcohol copolymer of the present invention, the bonding mode of the copolymer of the monomer unit represented by formula (1), the monomer unit represented by formula (2) and a monomer unit derived from unsaturated carboxylic acid or unsaturated carboxylic acid ester may be random or block, depending on polymerization conditions. In consideration for enhancement in compatibility with various resins, random mode is preferred.

In the allyl alcohol copolymer of the present invention, the composition of each monomer unit can be controlled by changing blending ratios between the allyl alcohol corresponding to the monomer unit represented by formula (1), the olefin compound corresponding to the monomer unit represented by formula (2) and the unsaturated carboxylic acid or unsaturated carboxylic acid ester at the time of conducting polymerization and polymerization conditions.

In consideration for achieving a good balance between compatibility of the allyl alcohol copolymer with various resins and adhesiveness, it is preferred that the concentration of the monomer unit represented by formula (1) be from 3 to 50 mol % based on the total monomer units, more preferably 4 to 40 mol %, most preferably 10 to 30 mol %. If the concentration of the monomer unit represented by formula (1) is less than 3 mol %, adhesiveness markedly decreases, and if it exceeds 50 mol %, compatibility with resins having low polarity decreases.

In a case where monomer units of unsaturated carboxylic acid or unsaturated carboxylic acid ester are contained, it is preferred that the concentration of such monomer units be from 0.1 to 5.0 mol % in consideration for achieving a good balance between compatibility of the allyl alcohol copolymer of the present invention with various resins and adhesiveness, more preferably 0.5 to 4.0 mol %, most preferably 2.0 to 3.0 mol %. If the concentration of monomer units of unsaturated carboxylic acid or unsaturated carboxylic acid ester is less than 0.1 mol %, compatibility with resins having high polarity decreases and if it exceeds 5 mol %, compatibility with resins having low polarity decreases.

It is preferred that the hydroxyl value of the allyl alcohol copolymer of the present invention be from 10 to 300 mgKOH/g in consideration for achieving a good balance between compatibility with various resins and adhesiveness, more preferably 50 to 250 mgKOH/g, most preferably 100 to 200 mgKOH/g. If the hydroxyl value of the copolymer is less than 10 mgKOH/g, adhesiveness decreases and if it exceeds 300 mgKOH/g, compatibility with resins having low polarity decreases. Here, the hydroxyl value is measured according to the method described in JIS K0070.

There is no particular limitation on the number average molecular weight (Mn) of the copolymer of the present invention in terms of polystyrene, which is measured by gel permeation chromatography (GPC). In consideration for compatibility with various resins, it is preferred that Mn be from 500 to 8000, more preferably 500 to 5000, most preferably 650 to 3000. If the number average molecular weight (Mn) in terms of polystyrene is less than 500, compatibility with solid resins decreases and if it exceeds 8000, compatibility with liquid resins decreases.

### [Production Method]

Next, the methods for producing the allyl alcohol copolymer of the present invention are explained.

The allyl alcohol copolymer of the present invention can be produced by either of the two methods, Method A and Method B, described below.

### Method A:

An allyl alcohol corresponding to the monomer unit represented by formula (1), an olefin compound corresponding to the monomer unit represented by formula (2), and if necessary an unsaturated carboxylic acid or unsaturated carboxylic acid ester, are copolymerized in the presence of a radical polymerization initiator.

### Method B:

A copolymer of an allyl alcohol and a radically-polymerizable aromatic monomer is hydrogenated. Method A: Radical copolymerization between an allyl alcohol corresponding to the monomer unit represented by formula (1), an olefin compound corresponding to the monomer unit represented by formula (2), and an unsaturated carboxylic acid or unsaturated carboxylic acid ester

There is no particular limitation on the olefin compound corresponding to the monomer unit represented by formula (2) used in copolymerization method in the present invention as long as the compound can be radically polymerizable. Examples of structures for olefin compound as explained in the above detailed description about the copolymer include straight chain terminal olefins such as 1-butene, 1-pentene, 1-hexene, 1-heptene, 1-octene, 1-decene, 1-dodecene, 1-tetradecene, 1-hexadecene, 1-octadecene, 1-eicosene and 1-tricosens, terminal olefins having a branched terminal such as 3-methyl-1-butene, 4-methyl-1-pentene, 3-methyl-1-pentene, 4,4-dimethyl-1-pentene, 3-methyl-1-heptene, 3-methyl-1-nonene and 3-methyl-1-undecene, and terminal olefins having a cyclic structure such as cyclohexyl ethylene, 3-cyclohexyl-1-propene, 4-cyclohexyl-1-butene, decahydronaphthalenyl ethylene and 4-vinyl-1-cyclohexene. In case of using olefin compound having an unsaturated bond at 2-position, such as 2-decene, polymerization is difficult due to resonance stabilization of living radicals.

Among them, particularly preferred in consideration for enhancement in compatibility with various resins are 1-butene, 1-pentene, 1-hexene, 1-heptene, 1-octene, 1-decene, 1-dodecene and cyclohexylethylene.

As for amounts of the allyl alcohol corresponding to the monomer unit represented by formula (1), the olefin compound corresponding to the monomer unit represented by formula (2), and the unsaturated carboxylic acid or unsaturated carboxylic acid ester used in this copolymerization reaction, it is preferred that the amount of the allyl alcohol be from 0.05 to 2.0 mol based on 1 mol of the olefin compound corresponding to the monomer unit represented by formula (2), particularly preferably 0.10 to 1.0 mol. If the amount of the allyl alcohol is less than 0.05 mol, the hydroxyl value of the obtained copolymer becomes too low, which leads to decrease in compatibility with resins, and if it exceed 2.0 mol, the molecular weight of the copolymer tends to decrease.

It is preferable that the amount of the unsaturated carboxylic acid or unsaturated carboxylic acid ester used here from 0.005 to 0.2 mol based on 1 mol of the olefin compound corresponding to the monomer unit represented by formula (2), particularly preferably 0.01 to 0.1 mol. If the amount of the unsaturated carboxylic acid or unsaturated carboxylic acid ester is less than 0.005 mol, the yield of the obtained copolymer decreases and if the amount exceeds 0.2 mol, solid matter having a high molecular weight is generated in the copolymer in some cases, which leads to white turbidity of the product. Here, since monomers differ in reactivity from each other, generally, the blending ratio of the monomers does not correspond with the quantitative ratio of the monomer units in the obtained polymer.

This copolymerization reaction may be conducted without a solvent or conducted with a solvent which does not react with the substrates and which has a small chain transfer constant. Example of such solvents include hydrocarbon solvents such as toluene, benzene and t-butylbenzene, ketone solvents such as acetone, and halogen solvents such as dichloromethane, chloroform, and chlorobenzene. One of these solvents may be used independently or two or more of them may be used in combination.

This copolymerization reaction may be conducted by using a radical polymerization initiator. Any radical polymerization initiator may be used as long as it can generate radicals by heat, ultraviolet ray, electron beam, radiation or the like. Preferred are those having a half-life of 1 hour or more at the reaction temperature.

Examples of heat radical polymerization initiator include azo compounds such as 2,2′-azobisisobutyronitrile, 2,2′-azobis(2,4-dimethylvaleronitrile), 2,2′-azobis(2-methylbutyronitrile), dimethyl 2,2′-azobisisobutyrate, 4,4′-azobis(4-cyanopentanoic acid), and 2,2′-azobis(2,4,4-trimethylpentane);

ketone peroxides such as methylethyl ketone peroxide,
methylisobutylketone peroxide and cyclohexanone peroxide;
diacyl peroxides such as benzoyl peroxide, decanoyl peroxide and lauroyl peroxide;
dialkyl peroxides such as dicumyl peroxide, t-butylcumyl peroxide and di-t-butyl peroxide;
peroxyketals such as 1,1-di(t-hexylperoxy)-3,3,5-trimethylcyclohexane, 1,1-bis(t-hexylperoxy)cyclohexane, 1,1-di-t-butylperoxycyclohexane and 2,2-di(t-butylperoxy) butane;
alkylperoxy esters such as t-butylperoxypivalate, t-butylperoxy-2-ethylhexanoate, t-butylperoxyisobutyrate, di-t-butylperoxyhexahydroterephthalate, di-t-butylperoxyazelate, t-butylperoxy-3,5,5-trimethylhexanoate, t-hexylperoxy-2-ethylhexanoate, 1,1,3,3-tetramethylbutylperoxy-2-ethylhexanoate, t-butylperoxyacetate, t-butylperoxybenzoate, di-t-butylperoxytrimethyladipate, t-hexylperoxyi sopropylmonocarbonate, t-butylperoxylaurate, and t-hexylperoxybenzoate;
peroxycarbonates such as diisopropylperoxydicarbonate, di-sec-butylperoxydicarbonate, and t-butylperoxyisopropyl carbonate; and hydrogen peroxides, but are not limited to these examples. One of these heat radical polymerization initiators may be used independently or two or more of them may be used in combination.

Examples of initiator for radical polymerization with UV, electron beam or radiation include acetophenone derivatives such as acetophenone, 2,2-dimethoxy-2-phenylacetophenone, diethoxyacetophenone, 1-hydroxy-cyclohexylphenylketone, 2-methyl-methyl-1-[4-(methylthio)phenyl]-2-morpholinopropanone-1,2-benzyl-2-dimethylamino-1-(4-morpholinophenyl)-butanone-1, and 2-hydroxy-2-methyl-1-phenylpropane-1-one;

Benzophenone derivatives such as benzophenone, 4,4′-bis(dimethylamino)benzophenone, 4-trimethylsilylbenzophenone and 4-benzoyl-4′-methyldiphenylsulfide;
Benzoin derivatives such as benzoin, benzomethylether, benzoinpropylether, benzoinisobutylether and benzoinisopropylether;
methylphenylglyoxylate, benzoindimethylketal, and 2,4,6-trimethylbenzoyldiphenylphosphineoxide, but are not limited to these examples. One of these initiators for radical polymerization with UV, electron beam or radiation may be used independently or two or more of them may be used in combination.

The use amount of the polymerization initiator varies depending on the reaction temperature and composition ratio of monomers and cannot be flatly defined. Generally, it is preferred that the amount be 0.1 to 15 parts by mass based on 100 parts by mass of the total amount of radically polymerizable monomers, particularly preferably 1 to 10 parts by mass. If the amount of the radical polymerization initiator to be added is less than 0.1 parts by mass, polymerization reaction does not readily proceed and if it exceeds 15 parts by mass, the molecular weight of the obtained copolymer becomes too low and such an excessive amount of the initiator is not preferred in consideration for the cost.

The reaction temperature (polymerization temperature) may be appropriately determined according to the type of the polymerization initiator. The temperature may be gradually changed in conducting the reaction (polymerization). In case of UV polymerization, room temperature may be employed. In case of heat polymerization, it is preferable that the reaction temperature be determined appropriately according to decomposition temperature of the initiator and generally, a preferred range is from 50 to 180° C. and a particularly preferred range is from 70 to 170° C. If the temperature is lower than 50° C., the reaction speed becomes extremely low and if it exceeds 180° C., not only decomposition of the radical initiator but also chain transfer proceeds too fast, which tends to reduce the molecular weight of the obtained copolymer.

After the reaction is completed, the allyl alcohol copolymer as reaction product is isolated by known operations and treatments (such as neutralization, solvent extraction, washing with water, liquid separation, distilling-off of solvent and reprecipitation).

### Method B: Hydrogenation of a Copolymer of an Allyl Alcohol and a Radically Polymerizable Aromatic Monomer

In Method B, first, a copolymer of an allyl alcohol and a radically polymerizable aromatic monomer is obtained. The aromatic ring of the copolymer is hydrogenated (hydrogenation). As such a copolymer of an allyl alcohol and a radically polymerizable aromatic monomer, a copolymer (allyl alcohol/styrene copolymer) obtained according to the method described in U.S. Pat. No. 5,444,141 or those commercially available may be used.

Examples of radically polymerizable aromatic monomer include styrene and vinyl toluene.

The hydrogenation reaction can be carried out by allowing an allyl alcohol, a radically polymerizable aromatic monomer and hydrogen gas to contact with each other in the presence of a catalyst.

Examples of catalyst used in the hydrogenation reaction include those containing as a catalyst component at least one metal element selected from Groups 6 to 12 in the periodic table. Specific examples thereof include catalysts comprising a combination selected from sponge nickel, Ni-diatomite, Ni-alumina, Ni-silica, Ni-silica-alumina, Ni-zeolite, Ni-titania, Ni-magnesia, Ni-chromia, Ni—Cu, Ni—Cu—Co, sponge Co, Co-diatomite, Co-alumina, Co-silica, Co-silica-alumina, Co-zeolite, Co-titania, Co-magnesia, sponge-Ru, Ru-carbon, Ru-alumina, Ru-silica, Ru-silica alumina, Ru-zeolite, Rh-carbon, Rh-alumina, Rh-silica, Rh-silica-alumina, Rh-zeolite, Pt-carbon, Pt-alumina, Pt-silica, Pt-silica-alumina, Pt-zeolite, Pd-carbon, Pd-alumina, Pd-silica, Pd-silica alumina and Pd-zeolite. Preferred among them are catalysts containing Rh, Ru or Pd as the catalyst component and particularly preferred are catalysts of Rh-carbon, Ru-carbon, Ru-alumina, Pd-carbon, and Pd-alumina.

There is no particular limitation on the method of preparing the catalyst and generally used method may be employed. Examples of the method include a method in which a carrier impregnated with a solution of a salt of a metal to serve as the catalyst is subjected to reduction treatment by using a reducing agent;

a method in which a carrier is impregnated with a solution of a salt of a metal to serve as the catalyst, allowed to contact with an alkali solution or the like to thereby precipitate metal oxide or oxide on the carrier, followed by calcining the oxide; a method in which a carrier is impregnated with a solution of a salt of a metal to serve as the catalyst, allowed to contact with an alkali solution or the like to thereby precipitate metal oxide or oxide on the carrier, followed by calcining the oxide, and then the resultant is subjected to reduction treatment by using a reducing agent; and a method in which an alloy of a metal and Al is prepared and the alloy is subjected to alkali treatment to thereby elute out Al. The present invention is not limited by these examples.

It is preferred that the hydrogenation reaction be conducted in liquid phase with a solvent for the purpose of removing reaction heat and reducing diffusion efficiency of hydrogen due to increase in viscosity. Any solvent can be used in the reaction as long as the solvent does not disturb the reaction. Specific examples thereof include one selected from halogenated hydrocarbons such as dichloromethane, chloroform, and 1,2-dichloroethane; aliphatic hydrocarbon solvents such as pentane, hexane, heptane and octane; ether solvents such as

diethylether, dipropylether, diisopropylether, dibutylether, ethyleneglycol dimethylether, ethyleneglycol diethylether, ethyleneglycol dibutylether, diethyleneglycol dimethylether, diethyleneglycol diethylether, diethyleneglycol dibutylether, tetrahydrofuran, and 1,4-dioxane; ether alcohol solvents such as 2-methoxyethanol, 2-ethoxyethanol, 2-propoxyethanol, 2-isopropoxyethanol, 2-butoxy ethanol, diethyleneglycol monomethylether, diethyleneglycol monoethylether, propyleneglycol monomethylether and propyleneglycol monoethylether; alcohol solvents such as methanol, ethanol, 1-propanol, 2-propanol, 1-butanol, 2-butanol, isobutyl alcohol and cyclohexanol; water; and a mixture solvent containing two or more of these solvents.

Preferred among them in consideration for solubility of hydrogen or the copolymer of an allyl alcohol and a radically polymerizable aromatic monomer are ether solvents and halogenated hydrocarbon solvents, and particularly preferred are tetrahydrofuran, 1,4-dioxane and chloroform.

As for hydrogen pressure in the hydrogenation reaction, the reaction may be carried out under normal pressure or increased pressure. In order for the reaction to proceed efficiently, increased pressure is preferred. Generally the reaction is carried out under a gauge pressure of 0 to 30 MPaG, preferably 1 to 20 MPaG, more preferably 2 to 15 MPaG.

Within a range that does not decrease the reaction efficiency of the catalyst, any temperature may be employed in the hydrogenation reaction. A general temperature range is 0 to 300° C., preferably 50 to 250° C., more preferably 70 to 220° C. If the temperature is too high, side-reactions readily occur and if the temperature is too low, practically useful reaction speed cannot be obtained.

As for the reaction mode of the hydrogenation reaction, any reaction mode generally used in general liquid-phase hydrogenolysis reaction or liquid-phase hydrogenation reaction, such as suspension bed batch reaction, fixed bed flow reaction and fluid bed flow reaction, may be employed according to the reaction process. The amount of the catalyst used in the reaction varies depending on the reaction mode and there is no particular limitation on the amount. In a batch process using a suspension bed, generally a range of the amount of the catalyst is 0.01 to 100 parts by mass based on 100 parts by mass of the copolymer of the allyl alcohol and the radically polymerizable aromatic monomer as the substrate, preferably 0.1 to 50 parts by mass, more preferably 0.5 to 20 parts by mass.

If the amount is too small, practically sufficient reaction speed cannot be obtained and if the amount is too large, side-reactions increase and costs for the catalyst also increases.

After completion of the hydrogenation reaction, the allyl alcohol copolymer as the reaction product is isolated by known procedures and treatment (such as filtration, eluting out with solvent, washing with water, separation, distilling-off of solvent and reprecipitation).

### EXAMPLES

Hereinafter, the present invention is described in greater detail by referring to Examples and Comparative Examples. The present invention is by no means limited thereto.

Properties of products synthesized in Examples and Comparative Examples were measured as follows.

### 1. FT-IR

Apparatus used: Spectrum GX
(manufactured by PerkinElmer, Inc.)

Measurement method: measured by liquid membrane technique using a KBr plate

### 2. ¹H-NMR, ¹³C-NMR

Apparatus used: JEOL EX-400
(400 MHz, manufactured by JEOL, LTD.)
   Measurement method: measured by dissolving samples in deuterated chloroform or deuterated methanol and using tetramethylsilane as internal standard.

### 3. Gel Permeation Chromatography (Gpc)

Apparatus used:

Column: Shodex GPC K-G+K-802+K-802.5+K-801 (manufactured by SHOWA DENKO K.K.),

Detector: Shodex SE-61 (manufactured by SHOWA DENKO K.K.),

Measurement Conditions

Solvent: Chloroform or tetrahydrofuran,

Measurement temperature: 40° C.,

Flow rate: 1.0 ml/minute,

Sample concentration: 1.0 mg/ml,

Injection amount: 1.0 μl,

Calibration curve: Universal Calibration curve,

Analysis program: SIC 48011 (product of System Instruments, Inc.)

### 4. Hydroxyl Value

The value was measured according to the method described in JIS K0070.

### Example 1

### Copolymerization of Allyl Alcohol and 1-Decene

A two-neck flask equipped with a thermometer, stirrer, and a condenser tube was purged with nitrogen in advance. Allyl alcohol (manufactured by SHOWA DENKO K.K., 2.0 g, 0.0344 mol), 1-decene (manufactured by Wako Pure Chemical Industries Co., Ltd., 16.15 g, 0.115 mol), and 2,2′-azobisisobutyronitrile (manufactured by Wako Pure Chemical Industries Co., Ltd., 0.908 g, 0.0055 mol) were placed in the flask. The flask was immersed in an oil bath and after the temperature was increased to 90° C., the mixture was stirred for 3 hours. The flask was cooled to 70° C., and the allyl alcohol and 1-decene that had remained unreacted were removed under reduced pressure at 70° C. Then the flask was cooled to room temperature and the content of the flask was dissolved in 20 ml of methanol. To the resultant, 200 ml of water was added and the mixture was stirred at room temperature for 30 minutes. After the stirring was stopped and the mixture was left standing for 10 minutes, the mixture was subjected to filtration to thereby remove the remaining initiator. Next, water, methanol and other substances having a low-boiling point were removed from the filtrate under reduced pressure at 80° C. to thereby obtain 2.56 g of an oily substance having high viscosity.

The ¹H-NMR, ¹³C-NMR and IR spectra of the obtained oily substance were measured and it was confirmed that the substance was the target copolymer. The results of ¹H-NMR, ¹³C-NMR and IR spectra are shown in FIGS. 1 to 3 respectively. The number average molecular weight of the copolymer (Mn) was 1320, the hydroxyl value was 125 mgKOH/g, and the concentration of the allyl alcohol monomer unit calculated by the hydroxyl value was 26.4 mol %. Also, the evaluation results on solubility in hexane, heptane, chloroform, methanol and acetone are shown in Table 2.

### Example 2

### Hydrogenation of Copolymer of Allyl Alcohol and Styrene

In a 120 ml-volume stainless-steel made autoclave (manufactured by Taiatsu Techno Corporation), copolymer of allyl alcohol and styrene (manufactured by Sigma-Aldrich, Inc., Mn=1200, hydroxyl value: 255 mgKOH/g, 6.0 g, allyl alcohol monomer unit: 40 mol %), 1,4-dioxane (manufactured by Wako Pure Chemical Industries Co., Ltd., 55.0 ml), and powdery 5% Rh-carbon (manufactured by Wako Pure Chemical Industries Co., Ltd., 0.7 g) were placed. After a flange was attached, the inside of the reaction system was substituted with nitrogen three times and then with hydrogen gas. Finally, a hydrogen pressure of 4.5 MPaG (gauge pressure) was applied thereto. Next, the temperature was increased while stirring the content at 400 rpm, and reaction was carried out at 200° C. for 7 hours. During the reaction, hydrogen was introduced so that the reaction pressure was constant.

After the content was cooled to room temperature, depressurization and substitution with nitrogen were carried out. The reaction container was opened to take out the content and the content was subjected to filtration to thereby remove catalyst. From the obtained filtrate, 1,4-dioxane was removed, to thereby obtain 5.9 g of a white solid substance.

The ¹H-NMR, ¹³C-NMR and IR spectra of the obtained white solid substance were measured and it was confirmed that the substance was the target copolymer. The results of ¹H-NMR, ¹³C-NMR and IR spectra are shown in FIGS. 4 to 6 respectively. The number average molecular weight of the copolymer (Mn) was 1220, the hydroxyl value was 242 mgKOH/g, and the concentration of the allyl alcohol monomer unit was 40 mol %. Also, the evaluation results on solubility in various solvents are shown in Table 2.

### Example 3

### Copolymerization of Allyl Alcohol and 1-Decene

In a 120 ml-volume stainless-steel made autoclave (manufactured by Taiatsu Techno Corporation), allyl alcohol (manufactured by SHOWA DENKO K.K., 2.00 g, 0.0344 mol), 1-decene (manufactured by Wako Pure Chemical Industries Co., Ltd., 48.3 g, 0.344 mol), and 2,2′-azobis(2,4,4-trimethylpentane) (manufactured by Wako Pure Chemical Industries Co., Ltd., 2.52 g, 0.0099 mol) were placed. After a flange was attached, the inside of the reaction system was substituted with nitrogen three times and then with hydrogen gas. Next, the temperature was increased while stirring the content at 400 rpm, and reaction was carried out at 130° C. for 5 hours.

After the content was cooled to room temperature, depressurization and substitution with nitrogen were carried out. The reaction container was opened to take out the content. From the content, the allyl alcohol and 1-decene that had remained unreacted and the remaining initiator were removed under reduced pressure at 100° C. to thereby obtain 10.44 g of an oily substance having high viscosity.

The ¹H-NMR, ¹³C-NMR and IR spectra of the obtained oily substance were measured and it was confirmed that the substance was the target copolymer. The number average molecular weight of the copolymer (Mn) was 810, the hydroxyl value was 54 mgKOH/g, and the concentration of the allyl alcohol monomer unit was 12.5 mol %. Also, the evaluation results on solubility in various solvents are shown in Table 2.

### Example 4

### Copolymerization of Allyl Alcohol and 1-Decene

In a 120 ml-volume stainless-steel made autoclave (manufactured by Taiatsu Techno Corporation), allyl alcohol (manufactured by SHOWA DENKO K.K., 4.00 g, 0.0688 mol), 1-decene (manufatured by Wako Pure Chemical Industries Co., Ltd., 48.3 g, 0.344 mol), and 2,2′-azobis(2,4,4-trimethylpentane) (manufatured by Wako Pure Chemical Industries Co., Ltd., 2.62 g, 0.0103 mol) were placed. After a flange was attached, the inside of the reaction system was substituted with nitrogen three times. Next, the temperature was increased while stirring the content at 400 rpm, and reaction was carried out at 130° C. for 5 hours.

After the content was cooled to room temperature, depressurization was carried out. The reaction container was opened to take out the content. From the content, the allyl alcohol and 1-decene that had remained unreacted and the remaining initiator were removed under reduced pressure at 100° C. to thereby obtain 9.02 g of an oily substance having high viscosity.

The ¹H-NMR, ¹³C-NMR and IR spectra of the obtained oily substance were measured and it was confirmed that the substance was the target copolymer. The number average molecular weight of the copolymer (Mn) was 780, the hydroxyl value was 89 mgKOH/g, and the concentration of the allyl alcohol monomer unit was 19.6 mol %. Also, the evaluation results on solubility in various solvents are shown in Table 2.

### Example 5

### Copolymerization of Allyl Alcohol and 1-Decene

In a 120 ml-volume stainless-steel made autoclave (manufactured by Taiatsu Techno Corporation), allyl alcohol (manufactured by SHOWA DENKO K.K., 6.00 g, 0.1032 mol), 1-decene (manufatured by Wako Pure Chemical Industries Co., Ltd., 48.3 g, 0.344 mol), and 2,2′-azobis(2,4,4-trimethylpentane) (manufatured by Wako Pure Chemical Industries Co., Ltd., 2.72 g, 0.0107 mol) were placed. After a flange was attached, the inside of the reaction system was substituted with nitrogen three times. Next, the temperature was increased while stirring the content at 400 rpm, and reaction was carried out at 130° C. for 5 hours.

After the content was cooled to room temperature, depressurization was carried out. The reaction container was opened to take out the content. From the content, the allyl alcohol and 1-decene that had remained unreacted and the remaining initiator were removed under reduced pressure at 100° C. to thereby obtain 8.83 g of an oily substance having high viscosity.

The ¹H-NMR, ¹³C-NMR and IR spectra of the obtained oily substance were measured and it was confirmed that the substance was the target copolymer. The number average molecular weight of the copolymer (Mn) was 730, the hydroxyl value was 127 mgKOH/g, and the concentration of the allyl alcohol monomer unit was 26.7 mol %. Also, the evaluation results on solubility in various solvents are shown in Table 2.

### Example 6

### Copolymerization of Allyl Alcohol and 1-Decene

In a 120 ml-volume stainless-steel made autoclave (manufactured by Taiatsu Techno Corporation), allyl alcohol (manufactured by SHOWA DENKO K.K., 6.50 g, 0.1120 mol), 1-decene (manufatured by Wako Pure Chemical Industries Co., Ltd., 39.3 g, 0.280 mol), and 2,2′-azobis(2,4,4-trimethylpentane) (manufatured by Wako Pure Chemical Industries Co., Ltd., 2.29 g, 0.0090 mol) were placed. After a flange was attached, the inside of the reaction system was substituted with nitrogen three times. Next, the temperature was increased while stirring the content at 400 rpm, and reaction was carried out at 130° C. for 5 hours.

After the content was cooled to room temperature, depressurization was carried out. The reaction container was opened to take out the content. From the content, the allyl alcohol and 1-decene that had remained unreacted and the remaining initiator were removed under reduced pressure at 100° C. to thereby obtain 7.30 g of an oily substance having high viscosity.

The ¹H-NMR, ¹³C-NMR and IR spectra of the obtained oily substance were measured and it was confirmed that the substance was the target copolymer. The number average molecular weight of the copolymer (Mn) was 670, the hydroxyl value was 184 mgKOH/g, and the concentration of the allyl alcohol monomer unit was 36.2 mol %. Also, the evaluation results on solubility in various solvents are shown in Table 2.

### Example 7

### Copolymerization of Allyl Alcohol and 1-Decene

In a 120 ml-volume stainless-steel made autoclave (manufactured by Taiatsu Techno Corporation), allyl alcohol (manufactured by SHOWA DENKO K.K., 8.00 g, 0.1377 mol), 1-decene (manufatured by Wako Pure Chemical Industries Co., Ltd., 39.3 g, 0.280 mol), and 2,2′-azobis(2,4,4-trimethylpentane) (manufatured by Wako Pure Chemical Industries Co., Ltd., 2.33 g, 0.0092 mol) were placed. After a flange was attached, the inside of the reaction system was substituted with nitrogen three times. Next, the temperature was increased while stirring the content at 400 rpm, and reaction was carried out at 130° C. for 5 hours.

After the content was cooled to room temperature, depressurization was carried out. The reaction container was opened to take out the content. From the content, the allyl alcohol and 1-decene that had remained unreacted and the remaining initiator were removed under reduced pressure at 100° C. to thereby obtain 7.28 g of an oily substance having high viscosity.

The ¹H-NMR, ¹³C-NMR and IR spectra of the obtained oily substance were measured and it was confirmed that the substance was the target copolymer. The results of ¹H-NMR, ¹³C-NMR and IR spectra are shown in FIGS. 7 to 9 respectively. The number average molecular weight of the copolymer (Mn) was 630, the hydroxyl value was 221 mgKOH/g, and the concentration of the allyl alcohol monomer unit was 41.7 mol %. Also, the evaluation results on solubility in various solvents are shown in Table 2.

### Example 8

### Copolymerization of Allyl Alcohol, 1-Decene and Dibutyl Maleate

A two-neck flask equipped with a thermometer, stirrer, and a condenser tube was purged with nitrogen in advance. Allyl alcohol (manufactured by SHOWA DENKO K.K., 5.81 g, 0.100 mol), 1-decene (manufactured by Wako Pure Chemical Industries Co., Ltd., 56.10 g, 0.400 mol), dibutyl maleate (manufactured by Wako Pure Chemical Industries Co., Ltd., 2.28 g, 0.010 mol) and 2,2′-azobis(2,4,4-trimethylpentane) (manufatured by Wako Pure Chemical Industries Co., Ltd., 3.19 g, 0.0125 mol) were placed in the flask. The flask was immersed in an oil bath and after the temperature was increased to 130° C., reaction was carried out for 5 hours. Then the flask was cooled to 70° C., and the allyl alcohol, 1-decene and dibutyl maleate that had remained unreacted were removed under reduced pressure at 70° C. Then the remaining initiator was removed by increasing the temperature to 100° C. under reduced pressure, to thereby obtain 6.61 g of an oily substance having high viscosity.

The ¹H-NMR, ¹³C-NMR and IR spectra of the obtained oily substance were measured and it was confirmed that the substance was the target copolymer. The results of ¹H-NMR, ¹³C-NMR and IR spectra are shown in FIGS. 10 to 12 respectively. The number average molecular weight of the copolymer (Mn) was 900, the hydroxyl value was 112 mgKOH/g, and the concentration of the allyl alcohol monomer unit based on the hydroxyl value was 23.3 mol %. The concentration of the dibutyl maleate monomer unit calculated by the hydroxyl value and the integration value by ¹H-NMR was 2.7 mol %. Also, the evaluation results on solubility in various solvents are shown in Table 2.

### Example 9

### Copolymerization of Allyl Alcohol, 1-Decene and Dimethyl Itaconate

A two-neck flask equipped with a thermometer, stirrer, and a condenser tube was purged with nitrogen in advance. Allyl alcohol (manufactured by SHOWA DENKO K.K., 5.81 g, 0.100 mol), 1-decene (manufactured by Wako Pure Chemical Industries Co., Ltd., 56.10 g, 0.400 mol), dimethyl itaconate (manufactured by Wako Pure Chemical Industries Co., Ltd., 1.58 g, 0.010 mol) and 2,2′-azobis(2,4,4-trimethylpentane) (manufatured by Wako Pure Chemical Industries Co., Ltd., 3.17 g, 0.0124 mol) were placed in the flask. The flask was immersed in an oil bath and after the temperature was increased to 130° C., reaction was carried out for 5 hours. Then the flask was cooled to 70° C., and the allyl alcohol, 1-decene and dimethyl itaconate that had remained unreacted were removed under reduced pressure at 70° C. Then the remaining initiator was removed by increasing the temperature to 100° C. under reduced pressure, to thereby obtain 8.60 g of an oily substance having high viscosity.

The ¹H-NMR, ¹³C-NMR and IR spectra of the obtained oily substance were measured and it was confirmed that the substance was the target copolymer. The results of ¹H-NMR, ¹³C-NMR and IR spectra are shown in FIGS. 13 to 15 respectively. The number average molecular weight of the copolymer (Mn) was 780, the hydroxyl value was 110 mgKOH/g, and the concentration of the allyl alcohol monomer unit calculated by the hydroxyl value was 22.7 mol %. The concentration of the dimethyl itaconate monomer unit calculated by the hydroxyl value and the integration value by ¹H-NMR was 2.5 mol %. Also, the evaluation results on solubility in various solvents are shown in Table 2.

### Example 10

### Copolymerization of Allyl Alcohol and 1-Octene

In a 120 ml-volume stainless-steel made autoclave (manufactured by Taiatsu Techno Corporation), allyl alcohol (manufactured by SHOWA DENKO K.K., 6.00 g, 0.1032 mol), 1-octene (manufactured by Wako Pure Chemical Industries Co., Ltd., 46.35 g, 0.410 mol), 2,2′-azobis(2,4,4-trimethylpentane) (manufactured by Wako Pure Chemical Industries Co., Ltd., 2.62 g, 0.0103 mol) were placed. After a flange was attached, the inside of the reaction system was substituted with nitrogen three times. Next, the temperature was increased while stirring the content at 400 rpm, and reaction was carried out at 130° C. for 5 hours.

After the content was cooled to room temperature, depressurization was carried out. The reaction container was opened to take out the content and from the content, the allyl alcohol and 1-octene that had remained unreacted and the remaining initiator were removed under reduced pressure at 100° C., to thereby obtain 6.98 g of an oily substance having high viscosity.

The ¹H-NMR, ¹³C-NMR and IR spectra of the obtained white solid substance were measured and it was confirmed that the substance was the target copolymer. The results of ¹H-NMR, ¹³C-NMR and IR spectra are shown in FIGS. 16 to 18 respectively. The number average molecular weight of the copolymer (Mn) was 670, the hydroxyl value was 158 mgKOH/g, and the concentration of the allyl alcohol monomer unit was 27.4 mol %. Also, the evaluation results on solubility in various solvents are shown in Table 2.

### Example 11

### Copolymerization of Allyl Alcohol and 1-Nonene

In a 120 ml-volume stainless-steel made autoclave (manufactured by Taiatsu Techno Corporation), allyl alcohol (manufactured by SHOWA DENKO K.K., 6.00 g, 0.1032 mol), 1-nonene (manufactured by Wako Pure Chemical Industries Co., Ltd., 52.15 g, 0.410 mol), 2,2′-azobis(2,4,4-trimethylpentane) (manufactured by Wako Pure Chemical Industries Co., Ltd., 2.91 g, 0.0114 mol) were placed. After a flange was attached, the inside of the reaction system was substituted with nitrogen three times. Next, the temperature was increased while stirring the content at 400 rpm, and reaction was carried out at 130° C. for 5 hours.

After the content was cooled to room temperature, depressurization was carried out. The reaction container was opened to take out the content and from the content, the allyl alcohol and 1-nonene that had remained unreacted and the remaining initiator were removed under reduced pressure at 100° C., to thereby obtain 8.71 g of an oily substance having high viscosity.

The ¹H-NMR, ¹³C-NMR and IR spectra of the obtained white solid substance were measured and it was confirmed that the substance was the target copolymer. The results of ¹H-NMR, ¹³C-NMR and IR spectra are shown in FIGS. 19 to 21 respectively. The number average molecular weight of the copolymer (Mn) was 690, the hydroxyl value was 132 mgKOH/g, and the concentration of the allyl alcohol monomer unit was 25.6 mol %. Also, the evaluation results on solubility in various solvents are shown in Table 2.

### Example 12

### Copolymerization of Allyl Alcohol and 1-Decene

In a 120 ml-volume stainless-steel made autoclave (manufactured by Taiatsu Techno Corporation), allyl alcohol (manufactured by SHOWA DENKO K.K., 16.3 g, 0.280 mol), 1-decene (manufactured by Wako Pure Chemical Industries Co., Ltd., 39.3 g, 0.280 mol), 2,2′-azobis(2,4,4-trimethylpentane) (manufactured by Wako Pure Chemical Industries Co., Ltd., 2.78 g, 0.0109 mol) were placed. After a flange was attached, the inside of the reaction system was substituted with nitrogen three times. Next, the temperature was increased while stirring the content at 400 rpm, and reaction was carried out at 130° C. for 5 hours.

After the content was cooled to room temperature, depressurization was carried out. The reaction container was opened to take out the content and from the content, the allyl alcohol and 1-decene that had remained unreacted and the remaining initiator were removed under reduced pressure at 100° C., to thereby obtain 5.52 g of an oily substance having high viscosity.

The ¹H-NMR, ¹³C-NMR and IR spectra of the obtained white solid substance were measured and it was confirmed that the substance was the target copolymer. The number average molecular weight of the copolymer (Mn) was 480, the hydroxyl value was 403 mgKOH/g, and the concentration of the allyl alcohol monomer unit was 63.3 mol %. Also, the evaluation results on solubility in various solvents are shown in Table 2.

### Comparative Example 1

### Copolymerization of Allyl Alcohol and Styrene

A two-neck flask equipped with a thermometer, stirrer, and a condenser tube was purged with nitrogen in advance. Allyl alcohol (manufactured by SHOWA DENKO K.K., 15.0 g, 0.258 mol) was placed in the flask. The flask was immersed in an oil bath and after the temperature was increased to 160° C., a separately-prepared liquid comprising a mixture of styrene (manufactured by Wako Pure Chemical Industries Co., Ltd., 3.3 g, 0.032 mol), and di-t-butylperoxide (Kishida Chemical Co., Ltd., 0.35 g 0.0024 mol) were added dropwise through a dropping funnel over 3 hours. After the dropping was completed, the mixture was stirred for 1 hour. Then the flask was cooled to 60° C. and allyl alcohol and styrene that had remained unreacted were removed under reduced pressure. Next, the flask was cooled to room temperature and the content was dissolved in 10 ml of methanol. The resultant was added to 150 ml of hexane and the mixture was stirred for 30 minutes. The stirring was stopped and the mixture was left standing for 10 minutes. Then an oily substance having high viscosity obtained through separation was collected.

From the substance, low-boiling point components were removed under reduced pressure at 80° C., to thereby obtain 3.35 g of a white solid substance.

The ¹H-NMR, ¹³C-NMR and IR spectra of the obtained oily substance were measured and it was confirmed that the substance was the target copolymer. The number average molecular weight of the copolymer (Mn) was 1450, the hydroxyl value was 112 mgKOH/g, and the concentration of the allyl alcohol monomer unit calculated by the hydroxyl value was 19.0 mol %. Also, the evaluation results on solubility in various solvents are shown in Table 2.

### Comparative Example 2

### Copolymerization of Allyl Alcohol and 2-Decene

A two-neck flask equipped with a thermometer, stirrer, and a condenser tube was purged with nitrogen in advance. Allyl alcohol (manufactured by SHOWA DENKO K.K., 0.40 g, 0.0069 mol), cis-2-decene (manufactured by Tokyo Chemical Industry Co., Ltd., 4.83 g, 0.0344 mol) and 2,2′-azobis(2,4,4-trimethylpentane) (manufactured by Wako Pure Chemical Industries Co., Ltd., 0.26 g, 0.0010 mol) were placed in the flask. The flask was immersed in an oil bath and after the temperature was increased to 130° C., reaction was carried out for 5 hours. Then the flask was cooled to 70° C. and allyl alcohol and cis-2-decene that had remained unreacted were removed under reduced pressure at 70° C. Next, when the remaining initiator was removed by increasing the temperature to 100° C., there remained nothing. That is, no copolymer was generated.

TABLE 1

| | | | | | | | | | | | | | | Comparative | |
|---|---|---|---|---|---|---|---|---|---|---|---|---|---|---|---|
| | | Examples | | | | | | | | | | | | Examples | |
| | | 1 | 2 | 3 | 4 | 5 | 6 | 7 | 8 | 9 | 10 | 11 | 12 | 1 | 2 |
| Monomer of | Allyl | 26.4 | 40.0 | 12.5 | 19.6 | 26.7 | 36.2 | 41.7 | 23.3 | 22.7 | 27.4 | 25.6 | 63.3 | 19.0 | 16.7 |
| formula (1) | alcohol | | | | | | | | | | | | | | |
| (mol %) | | | | | | | | | | | | | | | |
| Monomer of | 1-decene | 73.6 | | 87.5 | 80.4 | 73.3 | 63.8 | 58.3 | 74.0 | 74.8 | | | 36.7 | | |
| formula (2) | 1-octene | | | | | | | | | | 72.6 | | | | |
| (mol %) | 1-nonene | | | | | | | | | | | 74.4 | | | |
| | Styrene | | 60.0 | | | | | | | | | | | | |
| | (hydro- | | | | | | | | | | | | | | |
| | genated) | | | | | | | | | | | | | | |
| Other | styrene | | | | | | | | | | | | | 81.0 | |
| monomers | 2-decene | | | | | | | | | | | | | | 83.3 |
| (mol %) | | | | | | | | | | | | | | | |
| Unsaturated | Dibutyl | | | | | | | | 2.7 | | | | | | |
| carboxylic | maleate | | | | | | | | | | | | | | |
| acid (mol %) | Dimethyl | | | | | | | | | 2.5 | | | | | |
| | itaconate | | | | | | | | | | | | | | |
| Number | Mn | 1320 | 1220 | 810 | 780 | 730 | 670 | 630 | 900 | 780 | 670 | 690 | 480 | 1450 | Not |
| Average | | | | | | | | | | | | | | | Polymer- |
| molecular | | | | | | | | | | | | | | | ized |
| weight | | | | | | | | | | | | | | | |
| Hydroxyl | mgKOH/g | 125 | 242 | 54 | 89 | 127 | 184 | 221 | 112 | 110 | 158 | 132 | 403 | 112 | 0 |
| value | | | | | | | | | | | | | | | |

TABLE 2

| | Hexane | Heptane | Chloroform | Methanol | Acetone |
|---|---|---|---|---|---|
| Example 1 | X | ◯ | ◯ | ◯ | ◯ |
| Example 2 | X | ◯ | ◯ | ◯ | X |
| Example 3 | ◯ | ◯ | ◯ | ◯ | ◯ |
| Example 4 | ◯ | ◯ | ◯ | ◯ | ◯ |
| Example 5 | ◯ | ◯ | ◯ | ◯ | ◯ |
| Example 6 | ◯ | ◯ | ◯ | ◯ | ◯ |
| Example 7 | X | ◯ | ◯ | ◯ | ◯ |
| Example 8 | ◯ | ◯ | ◯ | ◯ | ◯ |
| Example 9 | ◯ | ◯ | ◯ | ◯ | ◯ |
| Example 10 | ◯ | ◯ | ◯ | ◯ | ◯ |
| Example 11 | ◯ | ◯ | ◯ | ◯ | ◯ |
| Example 12 | X | X | ◯ | ◯ | ◯ |
| Comparative | X | X | X | ◯ | ◯ |
| Example 1 | | | | | |

◯: soluble
X: Not soluble

### INDUSTRIAL APPLICABILITY

The allyl alcohol copolymer obtained by the method of the present invention has excellent compatibility with various resins and excellent adhesiveness thanks to its having a polar group and also, the copolymer has excellent electric insulation property, low water absorption, excellent thermal stability and excellent surface-active effects thanks to its having a hydrophobic group. Therefore, the copolymer is useful, for example, when used in resin improver, coating component, ink component, adhesive component, primer component, high-performance wax, compatibilizer, surfactant, urethane material and polyester material.

### BRIEF DESCRIPTION OF DRAWINGS

FIG. 1 is a ¹H-NMR spectrum of the copolymer obtained in Example 1.

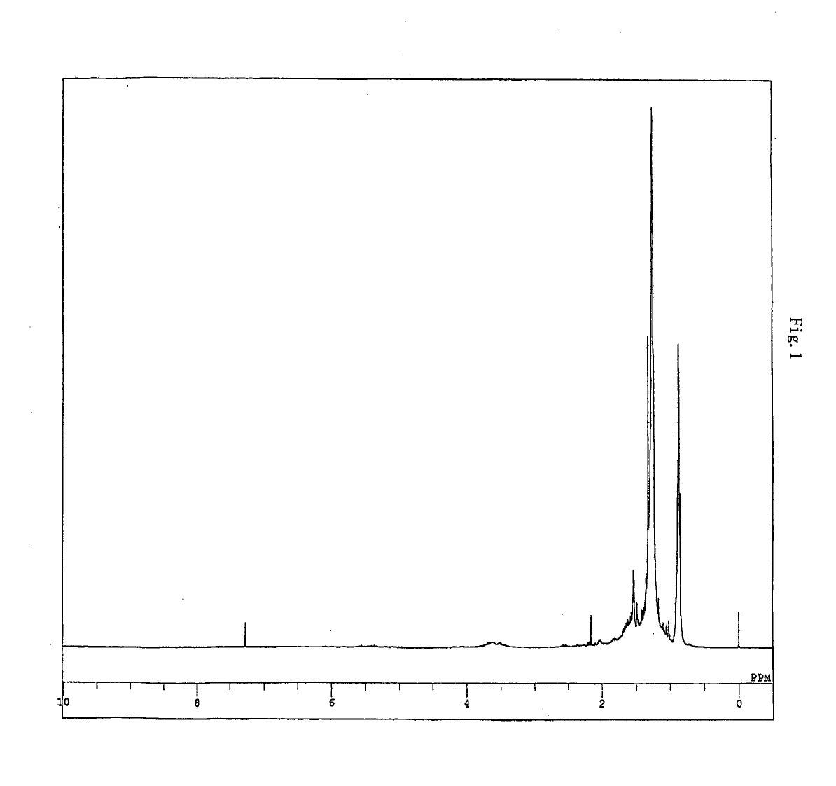

FIG. 2 is a ¹³C-NMR spectrum of the copolymer obtained in Example 1.

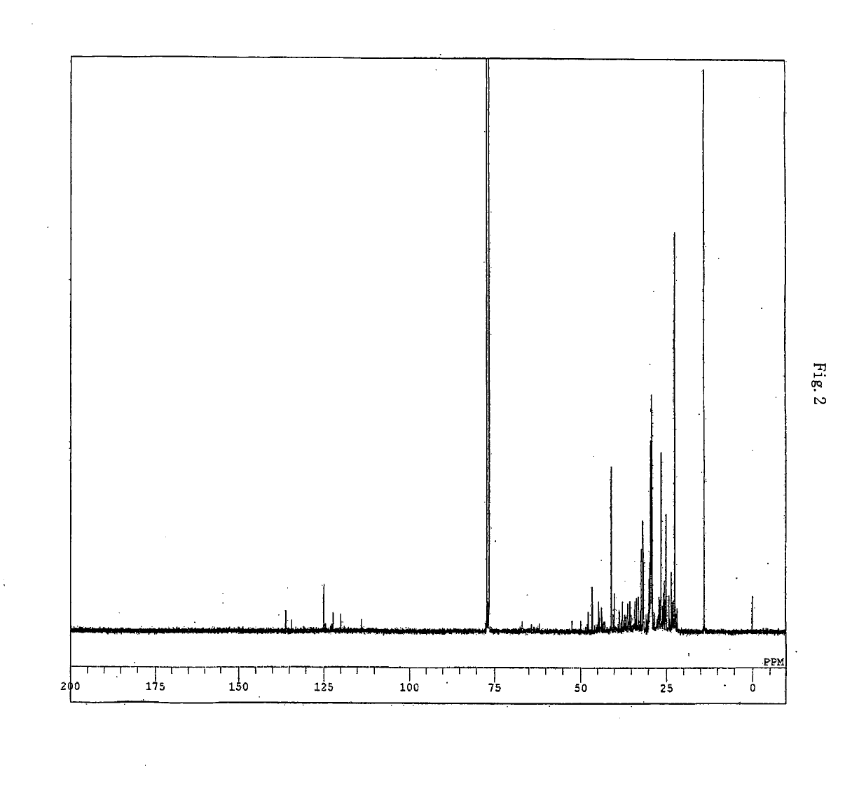

FIG. 3 is an IR spectrum of the copolymer obtained in Example 1.

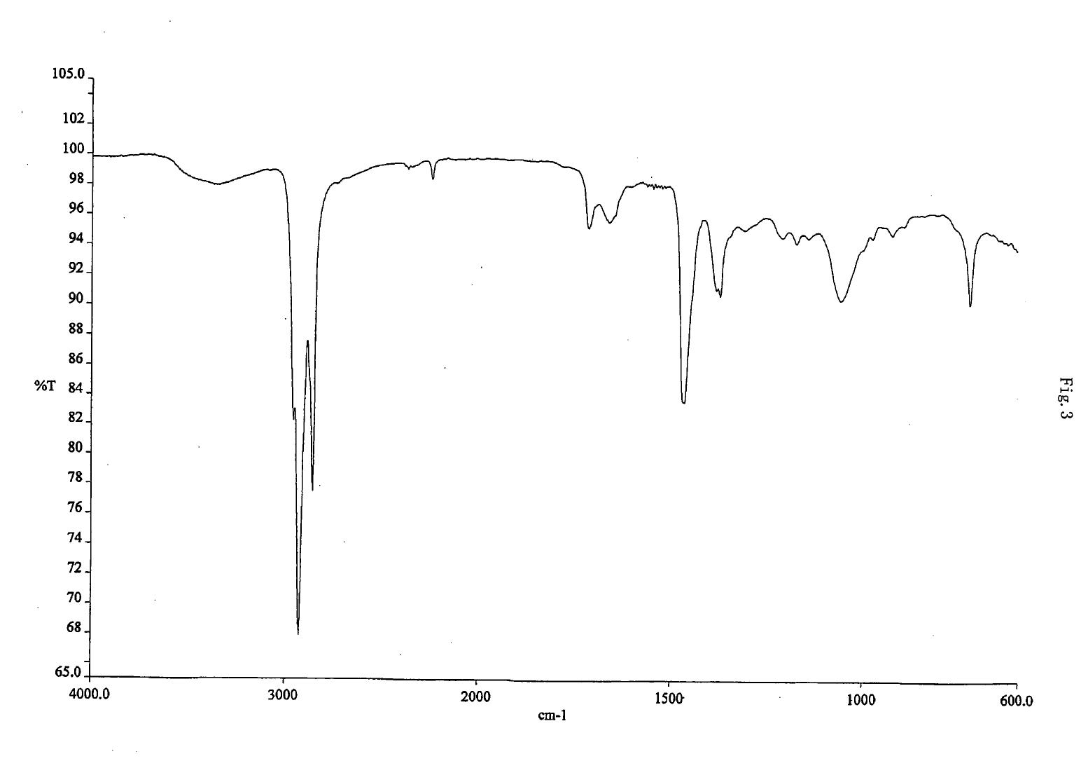

FIG. 4 is a ¹H-NMR Spectrum of the copolymer obtained in Example 2.

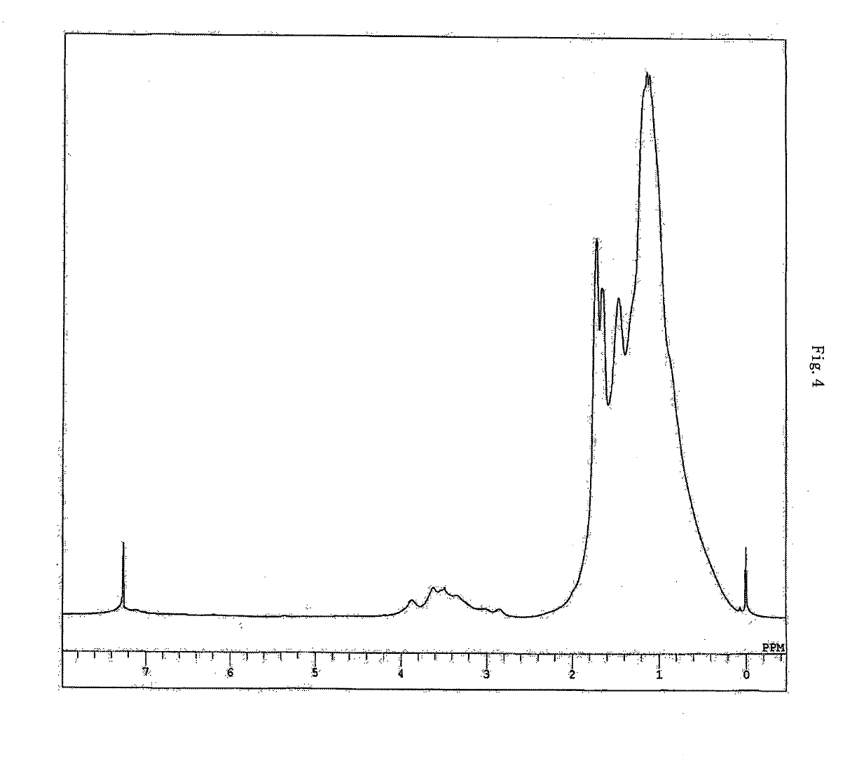

FIG. 5 is an ¹³C-NMR Spectrum of the copolymer obtained in Example 2.

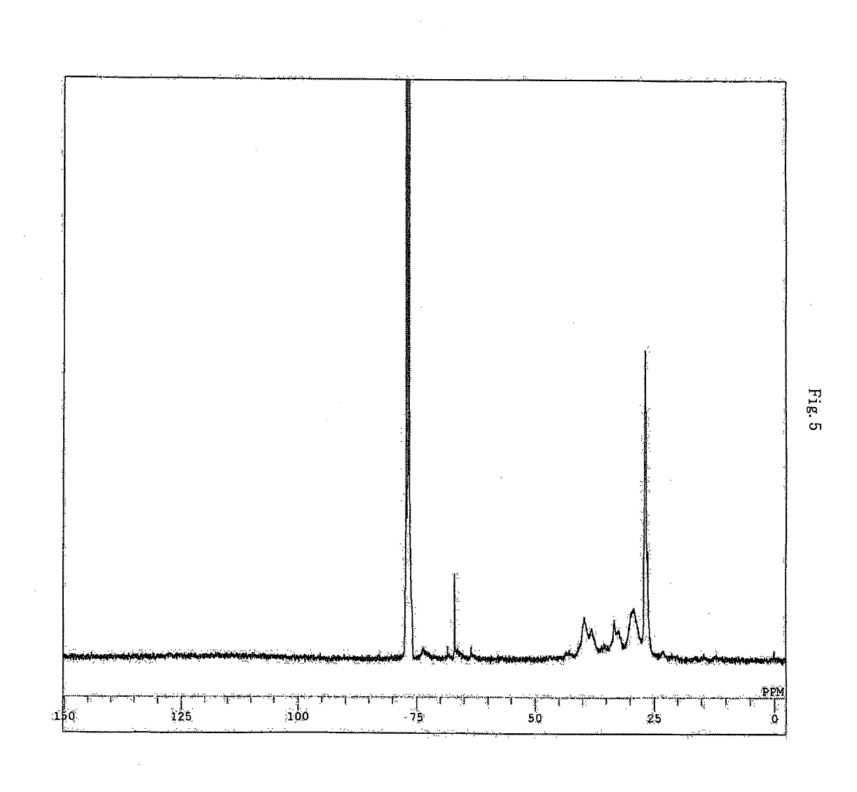

FIG. 6 is an IR Spectrum of the copolymer obtained in Example 2.

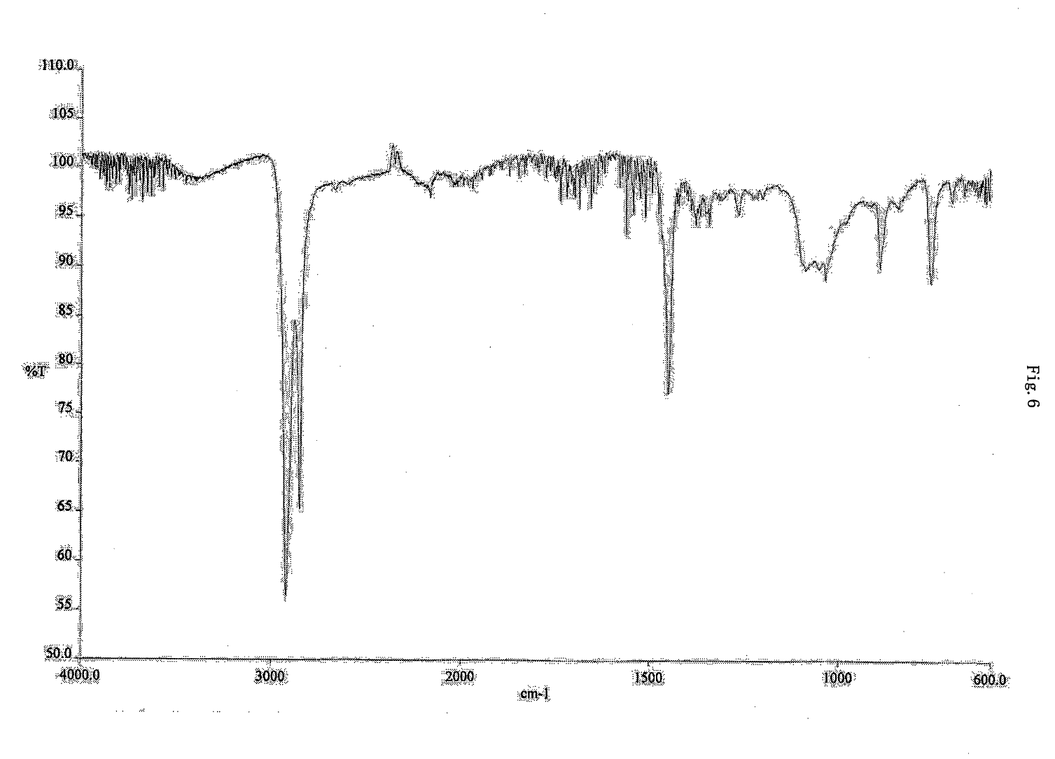

FIG. 7 is a ¹H-NMR Spectrum of the copolymer obtained in Example 7.

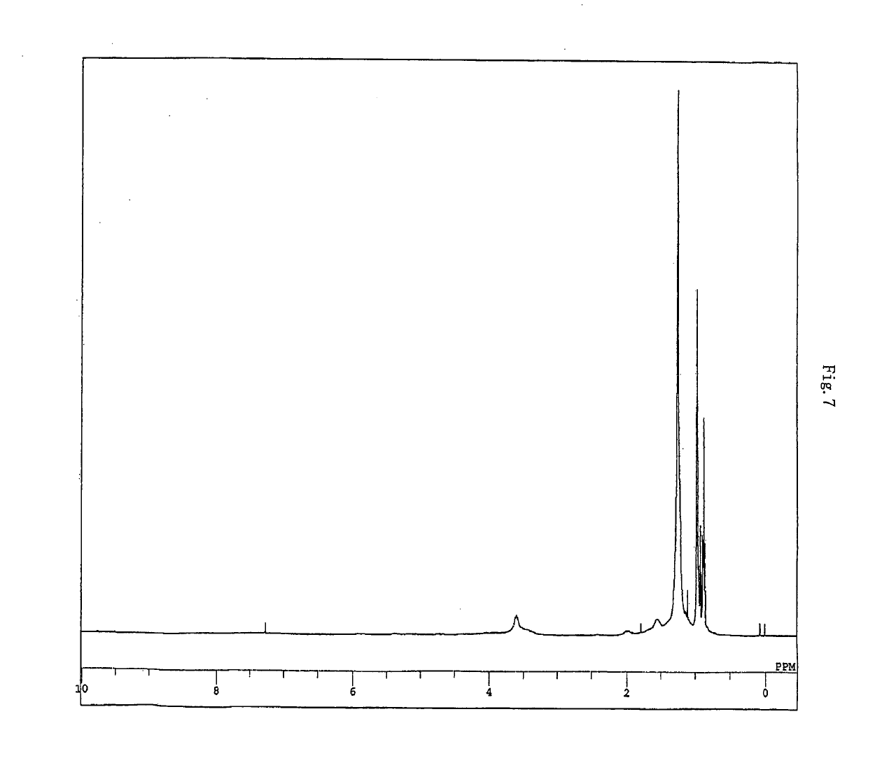

FIG. 8 is a ¹³C-NMR Spectrum of the copolymer obtained in Example 7

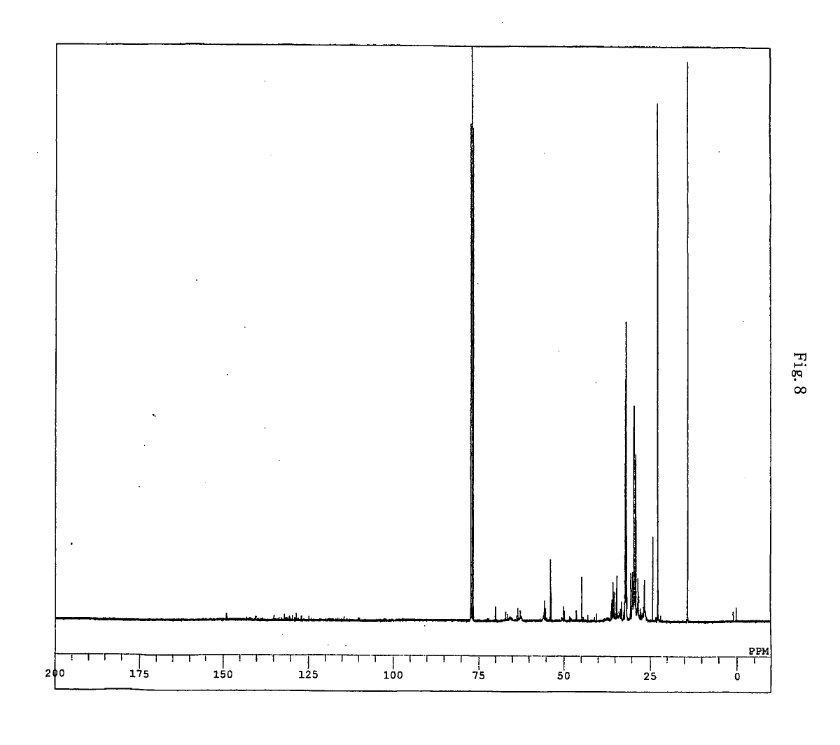

FIG. 9 is an IR Spectrum of the copolymer obtained in Example 7.

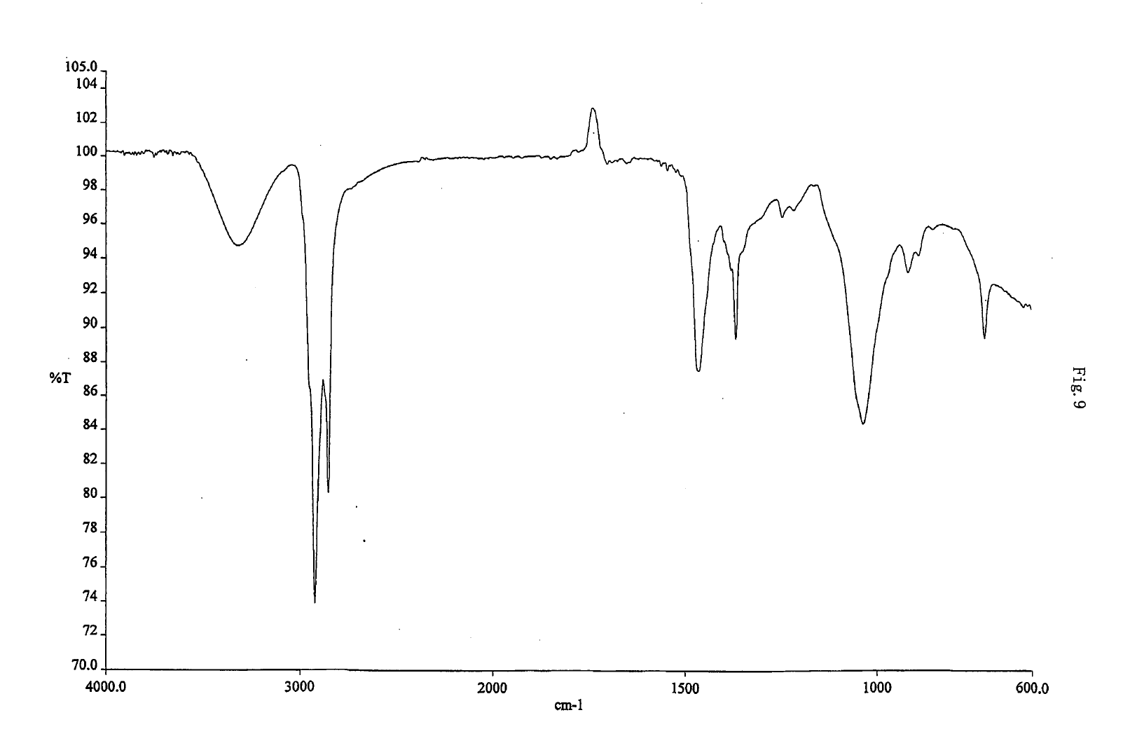

FIG. 10 is a ¹H-NMR Spectrum of the copolymer obtained in Example 8.

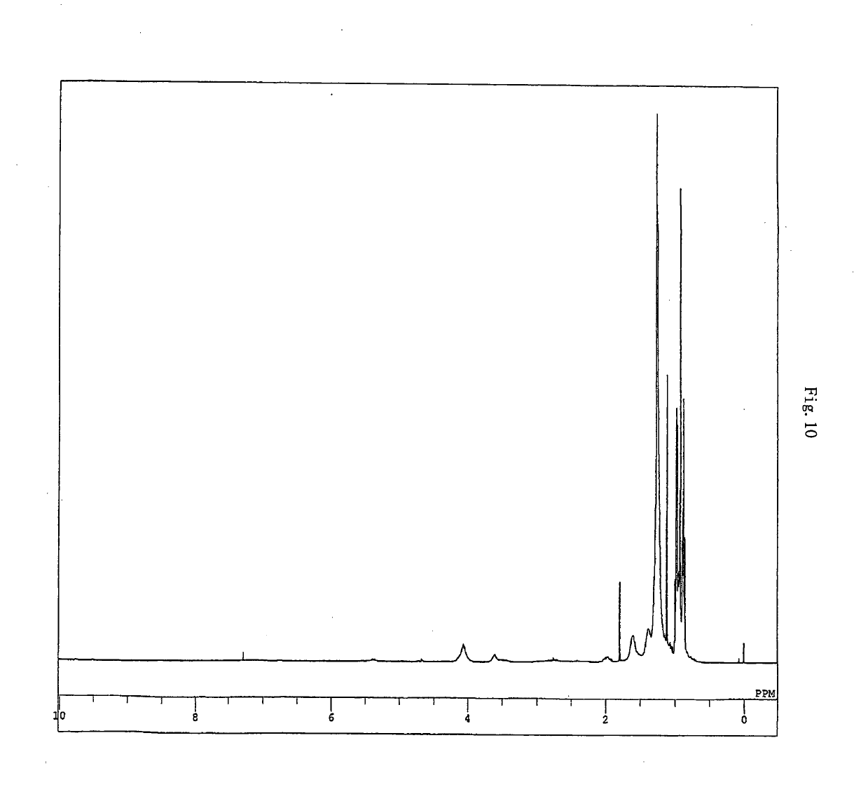

FIG. 11 is a ¹³C-NMR Spectrum of the copolymer obtained in Example 8.

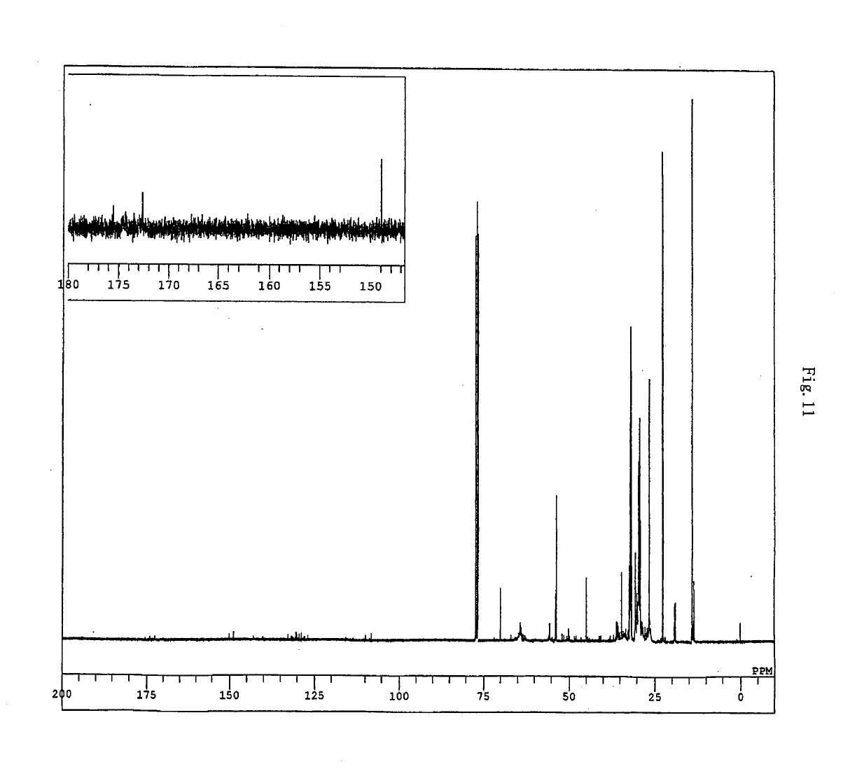

FIG. 12 is an IR Spectrum of the copolymer obtained in Example 8.

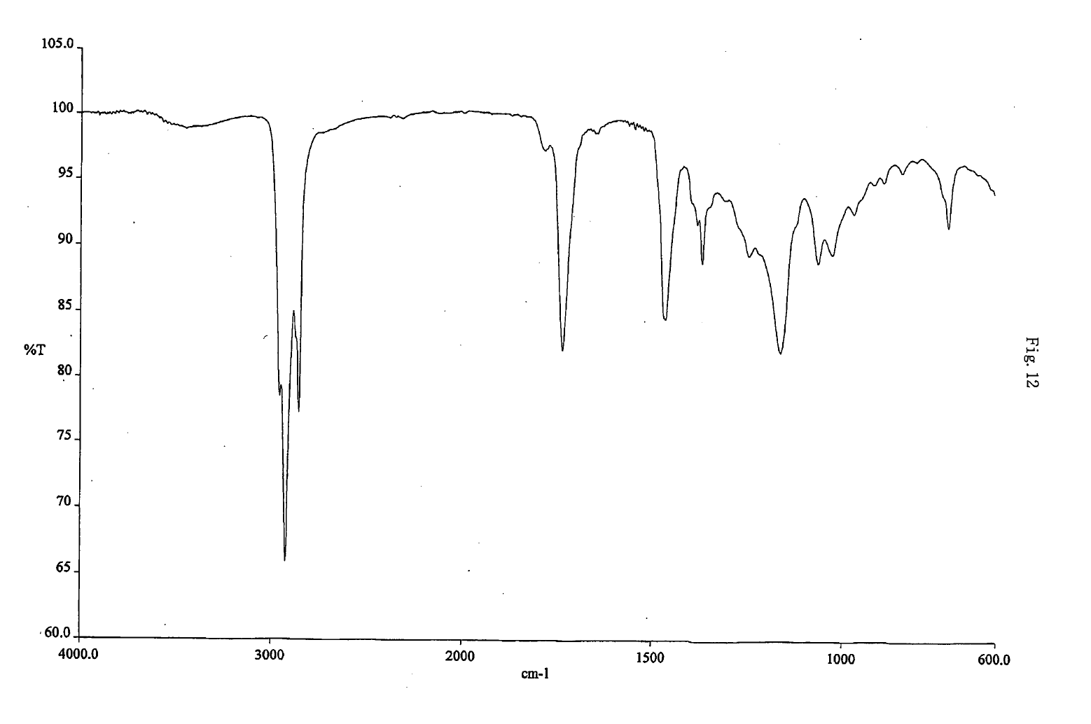

FIG. 13 is a ¹H-NMR Spectrum of the copolymer obtained in Example 9.

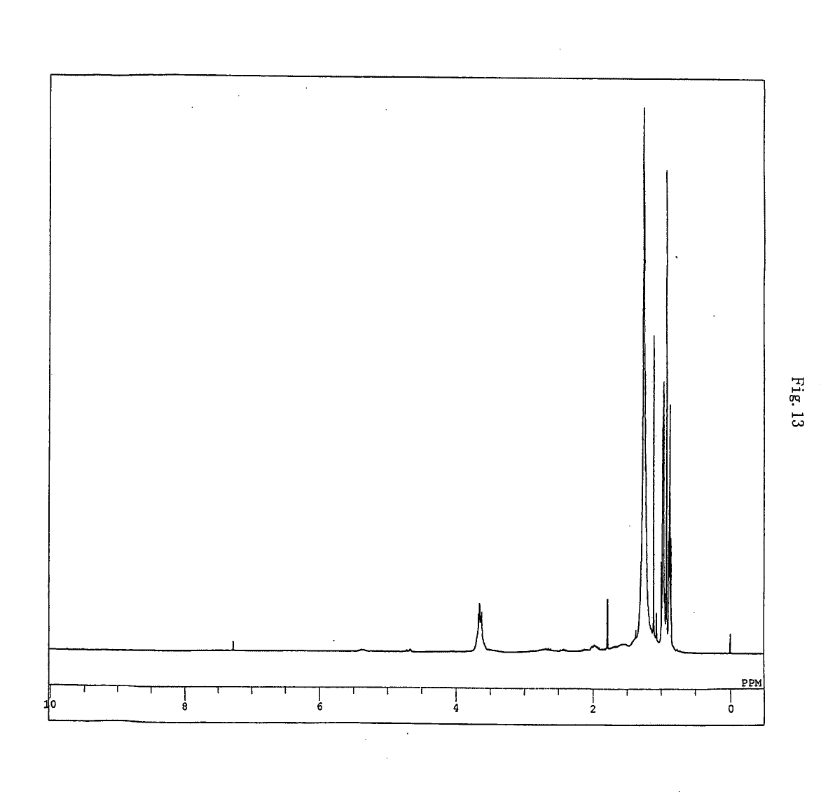

FIG. 14 is a ¹³C-NMR Spectrum of the copolymer obtained in Example 9

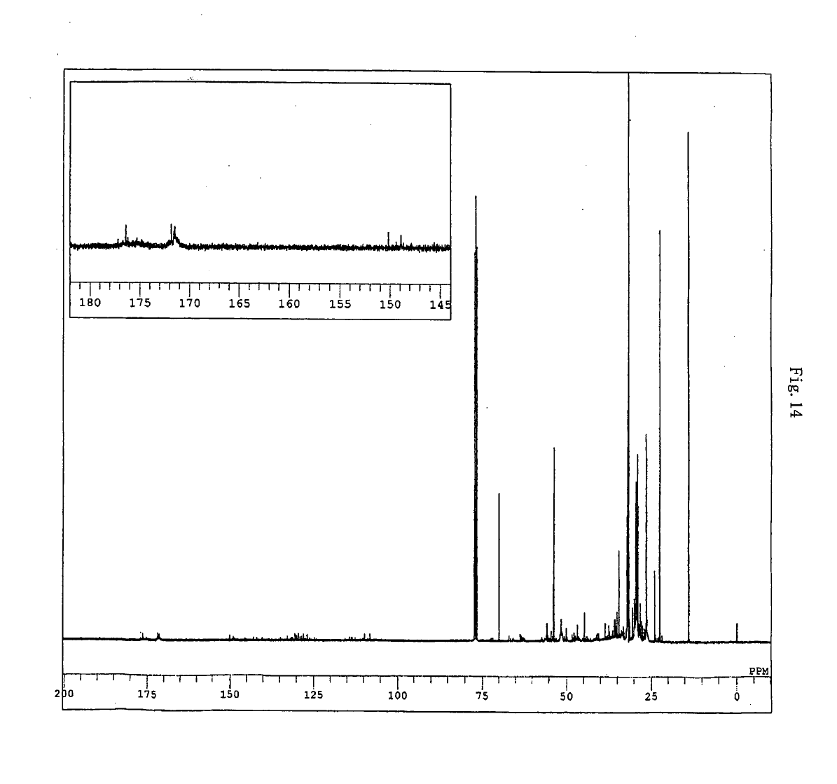

FIG. 15 is an IR Spectrum of the copolymer obtained in Example 9.

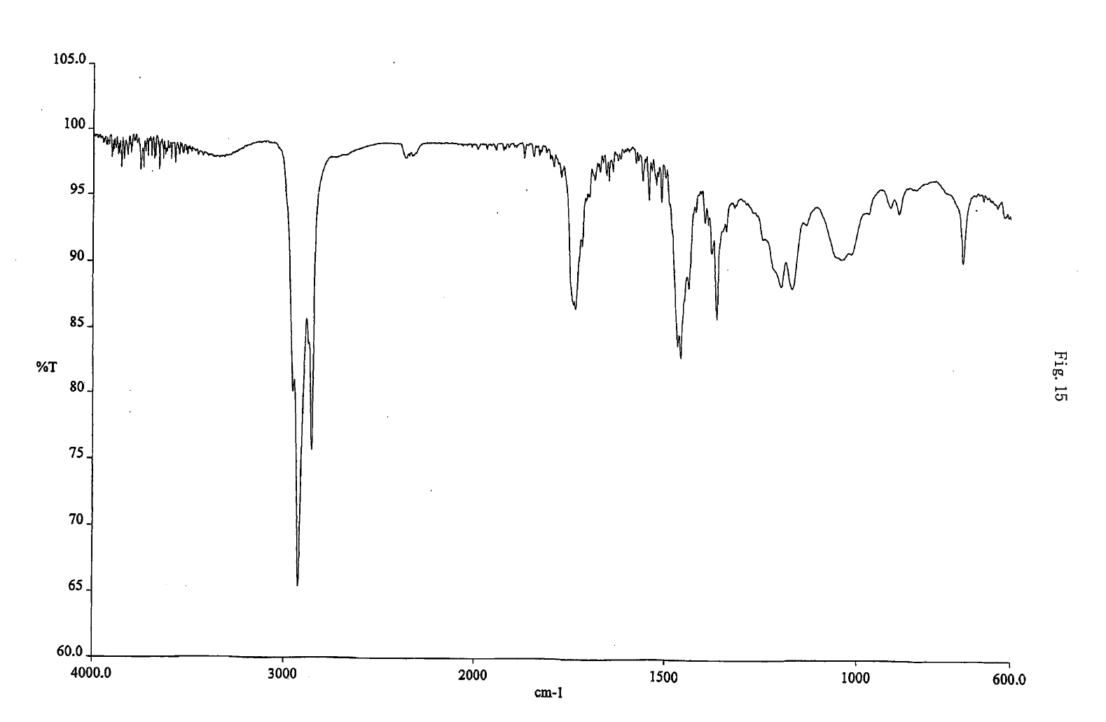

FIG. 16 is a ¹H-NMR Spectrum of the copolymer obtained in Example 10.

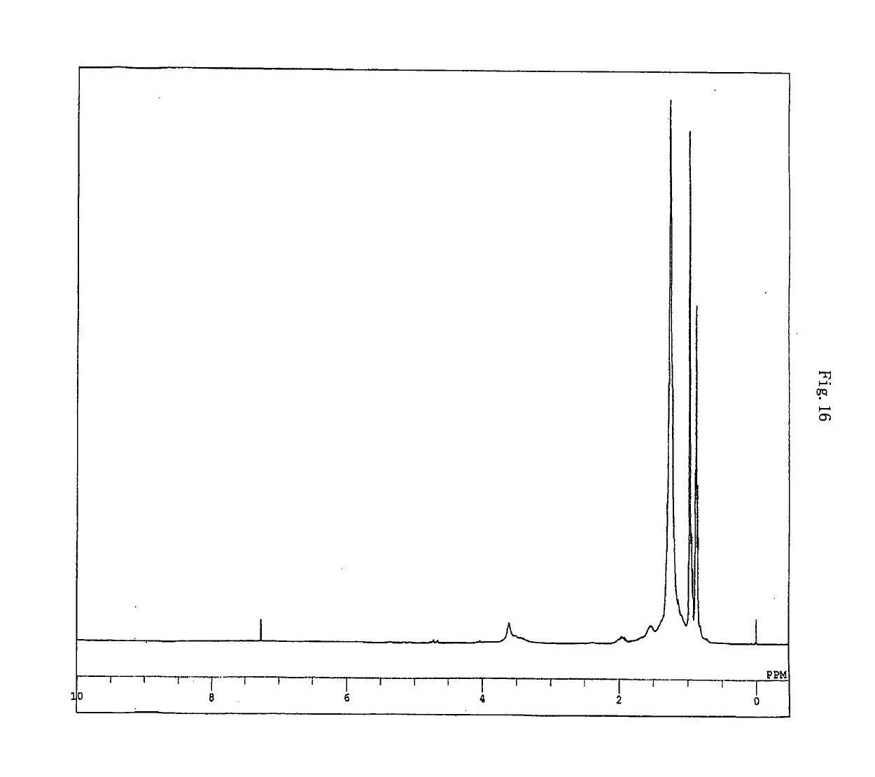

FIG. 17 is a ¹³C-NMR Spectrum of the copolymer obtained in Example 10.

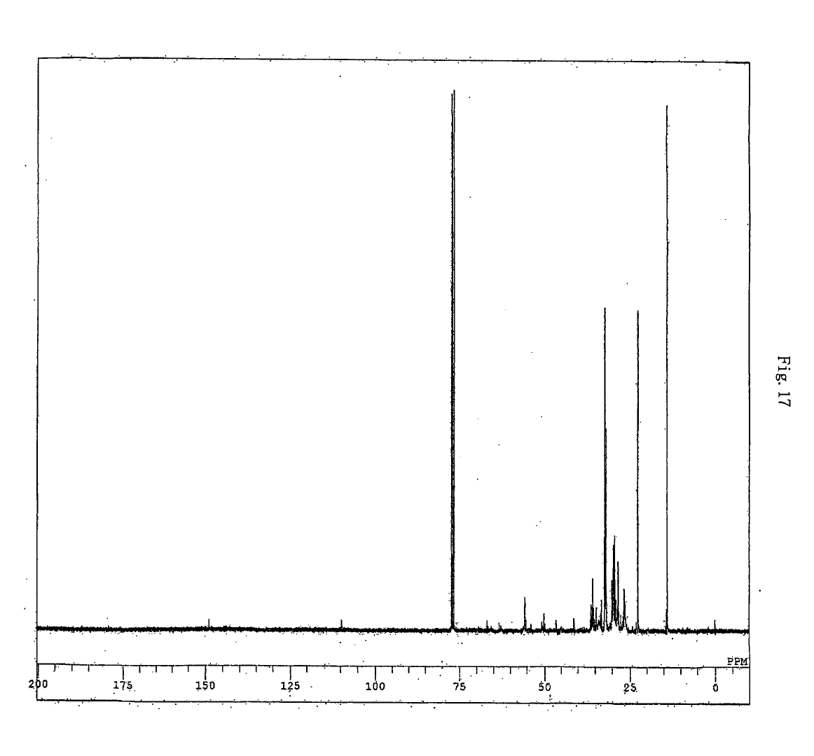

FIG. 18 is an IR Spectrum of the copolymer obtained in Example 10.

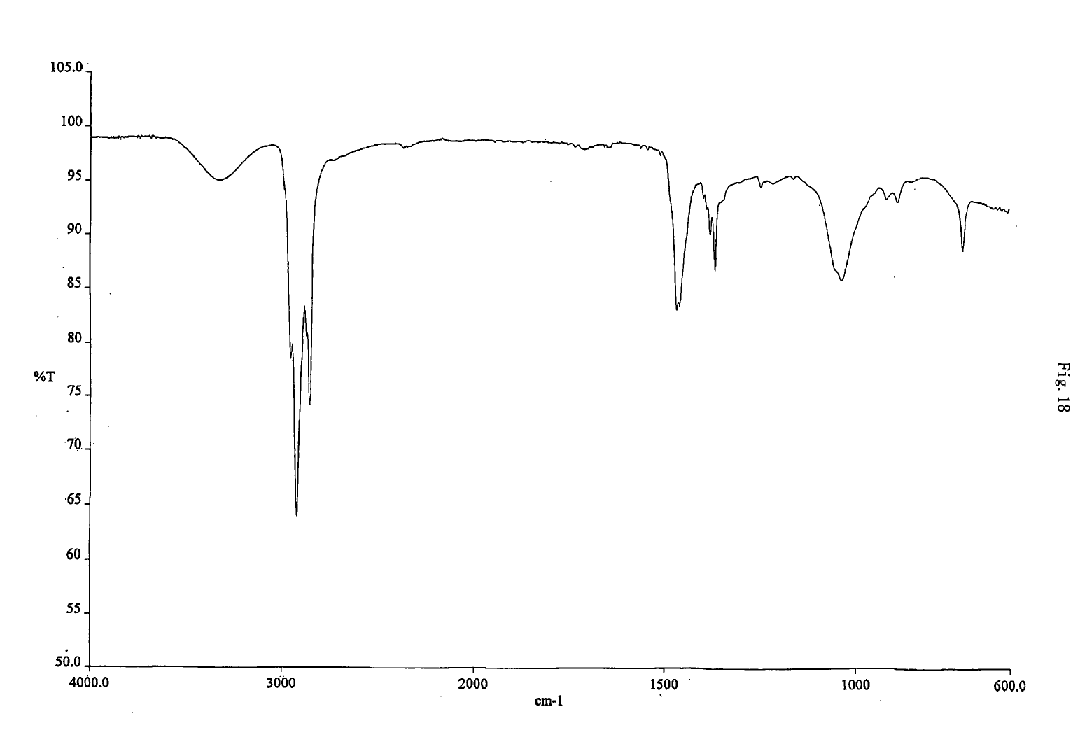

FIG. 19 is a ¹H-NMR Spectrum of the copolymer obtained in Example 11.

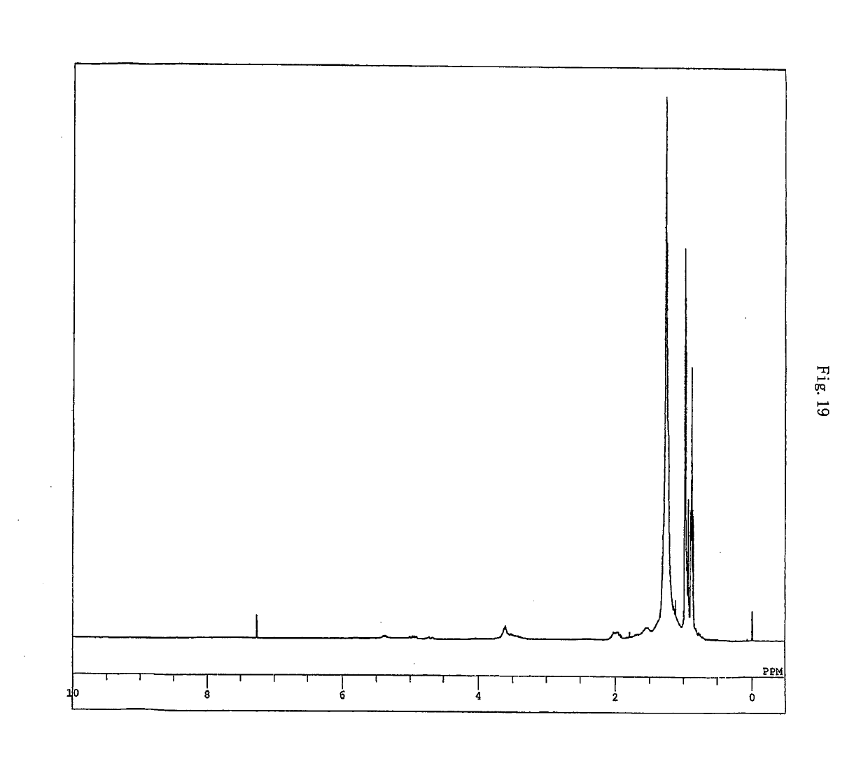

FIG. 20 is a ¹³C-NMR Spectrum of the copolymer obtained in Example 11.

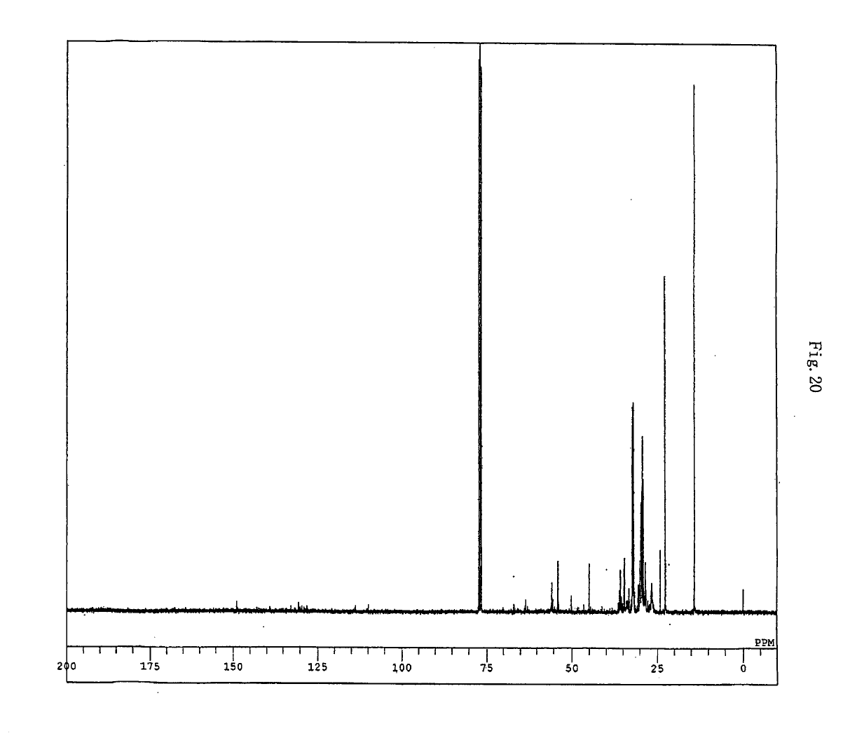

FIG. 21 is an IR Spectrum of the copolymer obtained in Example 11.

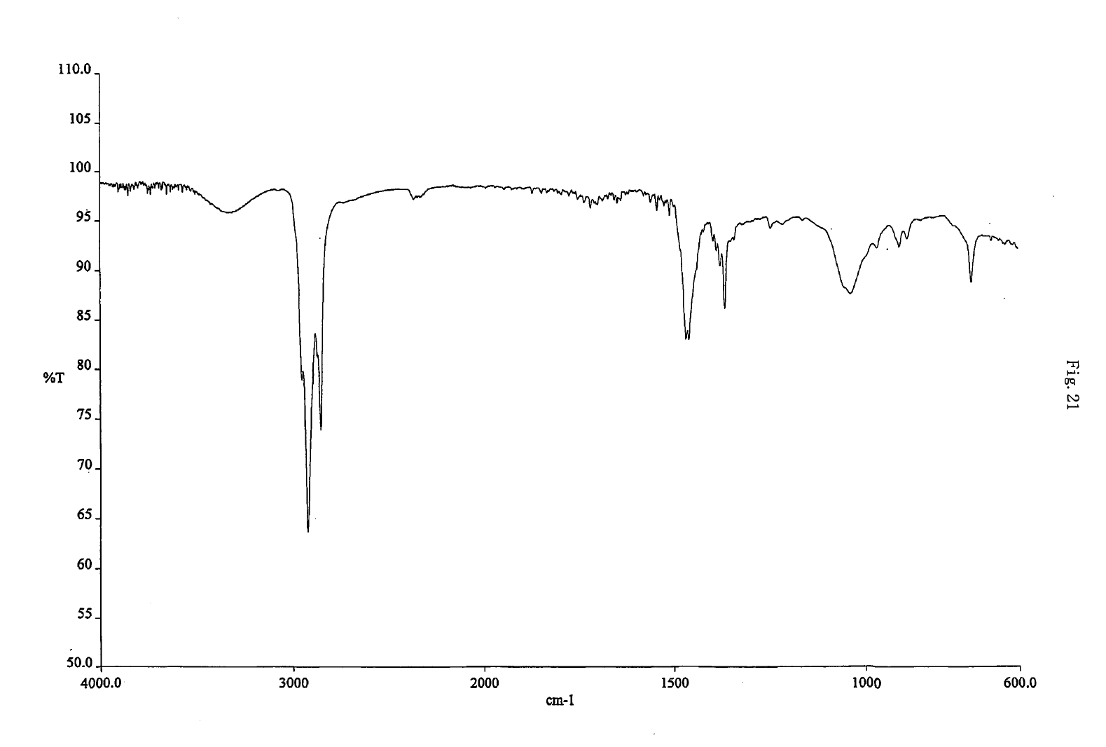

1-11. (canceled)

12. An allyl alcohol copolymer comprising as monomer units structures represented by formulae (1) and (2) only 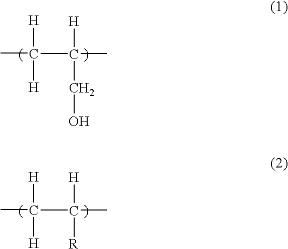
wherein R represents an aliphatic hydrocarbon group having 2 to 20 carbon atoms, which may be branched or include a cyclic structure.

13. The allyl alcohol copolymer according to claim 12, wherein the aliphatic hydrocarbon group having 2 to 20 carbon atoms represented by R in formula (2) is a linear aliphatic hydrocarbon group having 2 to 10 carbon atoms.

14. The allyl alcohol copolymer according to claim 12, wherein the aliphatic hydrocarbon group having 2 to 20 carbon atoms represented by R in formula (2) is an alicyclic hydrocarbon group having 6 to 10 carbon atoms.

15. The allyl alcohol copolymer according to claim 12, comprising 3 to 50 mol % of the monomer unit represented by formula (1).

16. The allyl alcohol copolymer according to claim 12, wherein the hydroxyl value is within a range of 10 to 300 mgKOH/g.

17. The allyl alcohol copolymer according to claim 12, wherein the number average molecular weight (Mn) is within a range of 500 to 8000.

18. A method of producing the allyl alcohol copolymer described in claim 12, comprising at least a step of copolymerizing an allyl alcohol and an olefin compound corresponding to formula (2) in the presence of a radical polymerization initiator.
